(19) United States
(12) Patent Application Publication
(10) Pub. No.: US 2009/0068423 A1
(43) Pub. Date: Mar. 12, 2009

(54) Food safe pet mats

(76) Inventor: Hallie A. Coletta, New City, NY (US)

Correspondence Address: ONOFRIO LAW, 15 N. MILL STREET - SUITE 225, NYACK, NY, 10960, US

(21) Appl. No.: 12/228,957

(22) Filed: Aug. 18, 2008

Related U.S. Application Data
(60) Provisional application No. 60/965,082, filed on Aug. 17, 2007.

(51) Int. Cl. B32B 3/10

(52) U.S. Cl. 428/203; 428/201; 156/277

(57) ABSTRACT

A pet mat comprised of a support; and an outer layer which is a plastic food safe, non-toxic coating; wherein an image is printed on at least one of the support surfaces; and a related method of producing the pet mat comprising the steps of providing a support; printing an image on at least one surface of said support; and laminating an outer layer over said image, wherein said outer layer is a plastic food safe non-toxic coating.

This application claims the benefit of U.S. provisional application No. 60/965,082 filed Aug. 17, 2007, which is incorporated herein in its entirety by reference.

### FIELD OF THE INVENTION

The present invention relates to a pet mat with a food-safe non-toxic coating. In particular, a multi-layered mat with a printed high quality digital image is provided with a non-skid backing.

### BACKGROUND OF THE INVENTION

Having a single pet can create problems at feeding time. Spills of food and water commonly occur. These problems increase when there are multiple animals in a household especially when there are many pet food bowls in an area on the kitchen floor or countertop.

Inexpensive plastic placemats are known in the prior art and are commercially available. These mats tend to be small, especially for multiple pets, and are not sophisticated at all.

The prior art discloses references relating to the general disclosure of mats. Representative examples include: U.S. Pat. No. 7,141,292 B1 to Kirby which discloses laminar mats and related methods of production; U.S. Pat. No. 6,173,675 B1 to Licciardo discloses aromatherapy mats for pets; U.S. Pat. No. 6,684,816 B2 to Lippincott discloses a pet area mat; U.S. Pat. No. 5,851,931 to DeRenzo et al. discloses a paintable substrate of nonwoven fabric and extruded resin; U.S. Pat. No. 4,907,539 to Abulhasan discloses a pet food bowl and mat; U.S. Pat. No. 4,649,861 to Elkins et al. discloses a pet mat; U.S. Design Pat. No. 386,838 to Pini et al. discloses a mat for pet feeding dish; U.S. Patent Publication No. 2005/0235919 AI to Willinger et al. and U.S. Patent Publication No. 2004/0237901 A to Tateosian et al. I both disclose pet mats; and U.S. Patent Publication No. 2002/0034912 A1 to Curro et al discloses applications for a laminate web.

The prior art also disclosed laminated and/or layered materials for use in pet mats. In particular, references U.S. Patent Publication No. 2005/0101201 A1 and U.S. Pat. No. 7,083,486 B2 both to Yeh disclose a layered material including a fabric layer laminated to a plastic film. FIG. 2 shows the composite material with a pattern on a film layer. U.S. Patent Publication No. 2006/015136 to Brazier et al. discloses a mat with a textile surface and an elastomer (rubber) backing layer.

Various “pet mats” are also available commercially on the internet.

www.amazon.com displays a Melia Canvas Pet Placement—Paw Design. The description says the product is a handpainted floor cloth sealed with a water resistant polyrurethane finish. The product retails for $43.95. The same product was also found at www.pawprintzpetboutique.com.

www.tastypettreats.com discloses a dye printed pet mat with a polyester surface and rubber backing. The product retails for $7.99. A similar product was found at www.ohmydogsupplies.com and www.muttropolis.com.

www.pet-soup.com displays “elite” series pet mat products retailing at $19.99 and up. Similar products were found at www.thepaw-risianbistro.com. These products are described as having designer patterns to complement any home décor and have non-slip backings.

www.roccoandjezebel.com and www.brookstone.com both disclose rubber pet food mats.

Unlike the present invention none of these patent references and products from the internet discloses a food safe pet mat which is a combination of an outer non-toxic coated layer over a digitally printed canvas substrate laminated to a non-skid rubber backing.

None of these products provide the specific structure of the invention pet mat which comprise an outer non-toxic food safe coated on top of a substrate that has been digitally printed and further laminated to a rubber backing and bound by a polyester (or like material) binder.

An advantage of the invention is in the provision of a pet mat comprised of a polyester/cotton canvas substrate laminated with a food-safe non-toxic coating. Images from originally created artwork are digitally reproduced on the canvas substrate. An outer coating is applied thereon to protect the image from scrubbing off during cleaning and also protects the pet from possibly licking the inks off the canvas substrate. A non-skid rubber backing is preferably glued to the side of the substrate surface opposite the outer coating. The entire mat is stitched with a binding, preferably 100% polyester binding to complete the product.

The invention mat is large enough to accommodate food bowls for several animals. It provides high quality and style, beautifies the home. The construction is high end and more substantial than any known pet mat product.

A general objective of the invention is to provide a food safe pet mat. Another object of the invention is to keep a pet feeding area floor or countertop surface clean.

An object of the invention is to provide a quality mat that beautifies the home.

Yet another object of the invention is to beautify the pet feeding area.

Another object of the invention is to protect the floor or counter surface from water damage.

A specific object of the invention is to provide an upscale pet product including reproductions of original artwork.

Another object of the invention is to show the pet that you care about them.

### SUMMARY OF THE INVENTION

In the present invention, these purposes, as well as others which will be apparent, are achieved generally by providing a pet mat comprised of a support; and an outer layer which is a plastic food safe non-toxic coating. A decorative image is printed on at least one of said support surfaces. The pet mat further has a backing on the support surface opposite the image.

In another embodiment of the invention, a mat is provided having a support, having an image printed on at least one surface; an outer layer on one surface of the support; and a backing on the opposite surface of the support. The outer layer is a cellulosic plastic coating that is food safe and non-toxic.

The invention also provides a method of making a food safe pet mat comprising the steps of providing a support; printing an image on at least one surface of the support; and laminating an outer layer over the image.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is an illustration of the general features of the pet mat;

FIG. 2 illustrates a preferred embodiment of the invention pet mat; and

FIG. 3 shows a frontal view of the invention pet mat with a border.

### DETAILED DESCRIPTION OF THE INVENTION

In accordance with the present invention a food safe pet mat is provided.

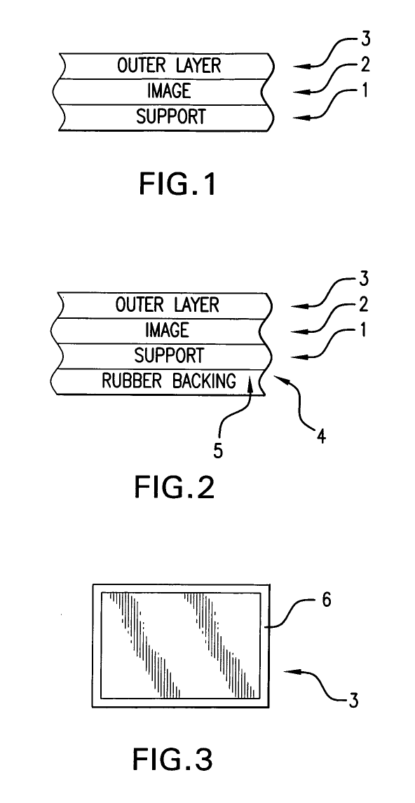

In general, FIG. 1 represents the pet mat of the invention comprising a support 1, and image 2 on at least on surface and an outer layer 3.

In FIG. 2 a preferred embodiment of the invention is shown where a backing 5 is on the support surface opposite the image. The backing is preferably a non-skid rubber backing which prevents the mat from sliding on the floor or counter surface. The backing also provides some cushion to the mat

The support is preferably a polyester/cotton canvas. Other materials which may be used are selected from the group consisting of paper, paperboard, canvas, plastic and other synthetic or cellulosic materials. Canvas material is eco-friendly and preferred because of the high image quality and durability.

The outer layer is a plastic food safe, non-toxic coating. The outer layer is translucent such that the image below can be seen. This layer serves to protect the image which is digitally printed with special inks. The image itself essentially gets absorbed into the canvas or support layer. The outer layer prevents the inks from possibly being licked off by the animal as it is eating and prevents the image from fading over time. This layer also provides a surface that is easily cleaned and scrubbed without disturbing the decorative image.

In preferred embodiments, the outer layer is made of Tenite cellulosic plastics commercially available from Eastman Chemical Co., Kingsport, Tenn. The Tenite materials—Tenite acetate, butyrate and propionate—are derived from natural resources—trees. In general the process of converting the raw tree material to plastic is described below.

The first step is isolating the cellulose from the trees. The bark is removed before pulping and is used as fuel for the conversion process itself. The tree is chipped and then cooked in a digester to separate cellulose fibers. Lignins and resins produced at this stage can also be used for other chemical products or as fuel. The resulting pulp of alpha cellulose and hemicellulose is treated with various bleaching chemicals to reduce the hemicellulose content and remove the last traces of lignins and resins. At this stage, the pulp is clean and white. It is pressed to remove water, then dried and wound onto rolls. This is the high-quality, high-alpha cellulose used to manufacture cellulose esters for plastics used for Tenite cellulosics.

The second step is converting the cellulose to a cellulose ester. Cellulose esters are made by reacting high-purity cellulose with selected acids and anhydrides in a multistage process. The choice of acids and anhydrides determines the chemical composition and properties of the final Tenite cellulosic plastic; the cellulosic plastics—acetate, butyrate, and propionate—are chemically different.

In esterification and hydrolysis, the cellulose, acids, and anhydrides are reacted under controlled catalyst concentrations and temperatures to determine the chemical make-up and viscosity of the cellulose ester. A viscous solution—the cellulose ester dissolved in acid—is formed at this stage. The solution then undergoes ultrafine filtration to remove traces of unreacted cellulose fibers and by-products. This ultrafine filtration is critical in making high-quality material required for injection molding and extrusion applications. Then, thru a precipitation process, the cellulose esters are separated from the viscous solution of water and acids as a solid powder. Following precipitation, the cellulose esters are washed to remove residual acids, then dried.

The final step is from cellulose ester to plastic. The cellulose ester, plasticizer, and additives are compounded in the final manufacturing step to produce the finished cellulosic plastic. A fully formulated Tenite cellulosic plastic will contain one of the three base esters and a variety of additives (such as plasticizers, heat stabilizers, slip agents, and ultraviolet inhibitors) compounded into a homogeneous mixture. To ensure high-quality formulations, each additive passes separate quality tests before it is used. Tenite acetate, butyrate, and propionate are available in a variety of formulations and plasticizer content ranging from 3% to 35% in 3.2-mm (⅛-in.) pellets for molding and extrusion. Tenite cellulosic plastics, noted for their excellent balance of properties, are available in a variety of formulas and plasticizer levels and can be tailored to the requirements of the user. As in the present invention, these materials have been customized for use to produce a food safe outer coating on a pet mat. None of the previously known uses for Tenite cellulosics have included such an application of the material. Other uses of the materials have been for ophthalmic sheets, tool handles, automotive and furniture trim, displays and profiles, pen barrels, appliance parts, cosmetic and personal care containers, film and tubing for packaging healthcare supplies, ophthalmic and optical safety frames, toothbrush handles and sunglasses.

Tenite cellulosics are easily molded, extruded, or fabricated. They are unique in their ability to accept various types of secondary fabrication including solvent polishing, cutting, cementing, drilling, and decorating.

The materials used in the invention are environmentally friendly. Because of the durable, nondisposable nature of cellulosic end products, recycling of Tenite cellulosic plastics is not an issue. Typical properties of the Tenite cellulosic plastics are summarized in Table 1 below.

TABLE 1
Typical Properties

| | | ASTM | Acetate | Butyrate | Propionate |
|---|---|---|---|---|---|
| Property | Unit | Method | 105-35 | 264-10 | 360-12 |
| Specific Gravity | | D 792 | 1.26 | 1.19 | 1.20 |
| Tensile Strength @ Yield | MPa | D 638 | 22.8 | 33.1 | 31.7 |
| [50 mm/min (2 in./min)] | psi | | 3,300 | 4,800 | 4,600 |
| Elongation @ Break [50 | % | D 638 | 30 | 50 | 45 |
| mm/min (2 in./min)] | | | | | |
| Flexural Modulus | MPa | D 790 | 1,300 | 1,400 | 1,400 |
| [1.27 mm/min (0.05 | 10⁵ psi | | 1.9 | 2.0 | 2.1 |
| in./min)] | | | | | |
| Flexural Yield Strength | MPa | D 790 | 33 | 46 | 41 |
| [1.27 mm/min (0.05 | psi | | 4,800 | 6,600 | 6,000 |
| in./min)] | | | | | |
| Izod Impact Strength, | J/m | D 256 | 235 (59) | 240 (96) | 416 (107) |
| Notched, @ 23° C. (−40° C.) | ft-lbf/in. | | 4.4 (1.1) | 4.5 (1.8) | 7.8 (2.0) |
| [3.2 mm × 12.7 mm (⅛ | | | | | |
| in. × ½ in.) specimen] | | | | | |

Deflection Temperature [conditioned 4 h @ 70° C. (158° F.)]

| | | | | | |
|---|---|---|---|---|---|
| 1.82 MPa | ° C. (° F.) | D 648 | 57 (135) | 74 (165) | 75 (167) |
| (264 psi) | | | | | |
| 0.455 MPa | ° C. (° F.) | | 70 (158) | 85 (185) | 83 (181) |
| (66 psi) | | | | | |
| Light Transmission [1.52 mm | % | E 308 | >90 | >90 | >90 |
| (0.06 in.) thickness] | | | | | |
| Haze [1.52 mm (0.06 in.) | % | D | <8.5 | <8.5 | <8.5 |
| thickness] | | 1003 | | | |
| Coefficient of Linear Thermal | mm/mm-° C. | D 696 | 11-17 × | 11-17 × | 11-17 × |
| Expansion | | | 10⁻⁵ | 10⁻⁵ | 10⁻⁵ |
| | in./in.-° F. | | 6-9 × | 6-9 × | 6-9 × |
| | | | 10⁻⁵ | 10⁻⁵ | 10⁻⁵ |
| Dielectric Strength | kV/mm | D 149 | 14.5 | 16.6 | 15.9 |
| | V/mil | | 368 | 422 | 404 |
| Dielectric Constant | @ 10⁶ Hz | D 150 | 3.5 | 3.3 | 3.3 |
| Dissipation Factor | @ 10⁶ Hz | D 150 | 0.05 | 0.02 | 0.03 |
| Volume Resistivity | ohm-cm | D 257 | 1.6 × | 1.6 × | 2.6 × |
| | | | 10¹³ | 10¹⁵ | 10¹⁵ |
| Surface Resistivity | ohms/sq | D 257 | 6.8 × | 1.4 × | 3.9 × |
| | | | 10¹⁴ | 10¹⁶ | 10¹⁶ |

In preferred embodiments a border around the perimeter of the pet mat is provided. This border 6 is illustrated in FIG. 3. The border is a material selected from the group consisting of polyester, cotton and other like material. The border material is attached to the mat itself preferably by hand stitching.

In an alternate embodiment a food safe mat is provided comprised of a support; and an outer layer, wherein an image is printed on at least one of said support surfaces.

In yet another embodiment of the invention a mat is provided comprised of a support, having an image printed on at least one surface; an outer layer on one surface of said support; and a backing on the opposite surface of said support.

The invention also provides a method of making a food safe pet mat comprising the steps of: providing a support; printing an image on at least one surface of said support; and laminating an outer layer over said image.

A non-skid backing is applied to the support surface, preferably being glued to the support surface.

A border is attached to the outer perimeter of the pet mat.

Original painted designs which may be painted are photographed and color corrected digitally. The designs are then digitally printed preferably on a 60/40 poly/cotton canvas using special solvent inks. A food safe plastic coating is laminated over the image. A non skid rubber backing is glued to the back of the support using water based latex glue. As desired a polyester colored binding is sewn around each mat. The stitching in all four corners of the mat are secured with a drop of hot glue.

In general the mats are rectangular and are in three preferred sizes: small (12″×16″), medium (16″×24″) and large (24″×30″). The thickness of the mats may vary but in preferred embodiments are approximately 7 mm.

The invention is intended to include other mats outside of these ranges, such as larger mats, runners (narrow and long rugs). Other shapes are also included in the invention and depend upon the desired end use. For example, boot mats, small rugs for an entry hall or porch etc. that are not just for pets but for the home.

The non skid backing is preferred so that the mat won't move around on the floor or counter surface while the pet eats. This is a common problem with dogs especially.

The support is preferably a sturdy canvas which protects the digitally printed image and also serves to protect the animal from the inks in the image. It further protects the floor or counter surface from pet food and water spills.

As mentioned above, the mats of the invention may also be used for people. Entry was mats, mats for boots and shoes, as a mat in front of the kitchen sink, as a rug in a room or on a porch. They can be made in different sizes and are comfortable to stand on because of the rubber backing material provides a cushion.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A pet mat comprised of:
a support; and
an outer layer which is a plastic food safe, non-toxic coating;
wherein an image is printed on at least one of said support surfaces.

2. The pet mat according to claim 1, further comprising a backing on said support surface opposite the image.

3. The pet mat according to claim 1, wherein said support is a polyester/cotton canvas.

4. The pet mat according to claim 1, wherein said support is selected from the group consisting of paper, paperboard, canvas, plastic and other synthetic or cellulosic materials.

5. The pet mat according to claim 1, wherein said outer layer is a cellulosic-plastic material.

6. The pet mat according to claim 1, wherein said outer layer is translucent such that the image below can be seen.

7. The pet mat according to claim 2, wherein said backing is a non-skid rubber backing.

8. The pet mat according to claim 1, further comprising a border around the perimeter of the pet mat.

9. The pet mat according to claim 8, wherein said border is a material selected from the group consisting of polyester, cotton and other like material.

10. A food safe mat comprised of:
a support; and
an outer layer which is a plastic food safe, non-toxic coating;
wherein an image is printed on at least one of said support surfaces.

11. The food safe mat according to claim 10, wherein said outer layer is a cellulosic-plastic material.

12. A mat comprised of:
a support, having an image printed on at least one surface;
an outer layer on one surface of said support, wherein said outer layer is a cellulosic plastic coating; and
a backing on the opposite surface of said support.

13. The pet mat according to claim 1, wherein said backing is a non-skid rubber backing.

14. A method of making a food safe pet mat comprising the steps of:
providing a support;
printing an image on at least one surface of said support; and
laminating an outer layer over said image, wherein said outer layer is a plastic food safe non-toxic coating.

15. The method as defined in claim 14, further comprising applying a non-skid backing to said support surface.

16. The method as defined in claim 15, wherein said non-skid backing is glued to said support surface.

17. The method as defined in claim 14, further comprising attaching a border to the outer perimeter of the pet mat.

18. The method according to claim 14, wherein said outer layer is a cellulosic-plastic material.

19. The method according to claim 14, wherein said support is selected from the group consisting of consisting of paper, paperboard, canvas, plastic and other synthetic or cellulosic materials.

20. The method according to claim 14, wherein said support is a polyester/cotton canvas.
